(19) United States
(12) Patent Application Publication
(10) Pub. No.: US 2025/0329063 A1
(43) Pub. Date: Oct. 23, 2025

(54) IMAGE PROCESSING DEVICE AND IMAGE PROCESSING METHOD

(71) Applicant: Panasonic Intellectual Property Management Co., Ltd., Osaka (JP)

(72) Inventors: Shigeru SAITOU, KYOTO FU (JP); Hiromu KITAJIMA, HYOGO KEN (JP); Yusuke YUASA, KYOTO FU (JP)

(21) Appl. No.: 18/852,202

(22) PCT Filed: Mar. 29, 2023
(86) PCT No.: PCT/JP2023/012800

§ 371 Date: Sep. 27, 2024

(30) Foreign Application Priority Data
Mar. 31, 2022 (JP) 2022-058965

(51) Int. Cl. G06T 11/00; G06V 10/62

(52) U.S. Cl. CPC G06T 11/00; G06V 10/62

(57) ABSTRACT

A static pixel value derivation unit derives a static pixel value of a static pixel in an image based on a temporal change in a pixel value of each pixel in the image. A static image generation unit generates a static image indicating the static pixel value for each pixel based on the static pixel value.

### TECHNICAL FIELD

The technology disclosed herein relates to an image processing device and an image processing method.

### BACKGROUND ART

Patent document 1 discloses a stereo measurement device. The stereo measurement device includes a first motion region extractor, a second motion region extractor, and a stereo matching unit. The first motion region extractor extracts a motion region from a first image captured by a first camera. The second motion region extractor extracts a motion region from a second image captured by a second camera. The stereo matching unit performs stereo matching only for the motion region extracted from the first image and the second image to obtain distance information of the object shown in the motion region.

### CITATION LIST

### Patent Document

Patent Document 1: Japanese Unexamined Patent Publication No. 2009-68935

### SUMMARY OF THE INVENTION

### Technical Problem

There is no disclosure or suggestion in Patent Document 1 as to how the pixels (static pixels) in the rest of areas of the first and second images, other than the motion region, are used and there is no disclosure or suggestion of generating a static image using the pixel values of the static pixels.

### Solution to the Problem

The present disclosure relates to an image processing device that processes an image captured by an image device at each predetermined time. The image processing device includes a controller connected to the image device, and the controller includes: a static pixel value derivation unit configured to derive a static pixel value of a static pixel in an image, based on a temporal change in a pixel value of each pixel in the image, and a static image generation unit configured to generate a static image indicating a static pixel value for each pixel based on the static pixel value.

The present disclosure relates to a image processing method that processes an image captured by an image device at each predetermined time. The image processing method includes: deriving a static pixel value of a static pixel in an image based on a temporal change in the pixel value of each pixel in the image, and generating a static image indicating a static pixel value for each pixel based on the static pixel value.

### Advantages of the Invention

According to the present disclosure, the pixel values of static pixels can be used to generate static images.

### BRIEF DESCRIPTION OF THE DRAWINGS

FIG. 1 is a block diagram illustrating a configuration of an image processing device according to an embodiment.

FIG. 2 is a block diagram illustrating a functional configuration of a controller.

FIG. 3 is a flowchart for explaining the operation of an image processing device.

FIG. 4 is a flowchart for explaining the operation of an image processing device.

FIG. 5 is a conceptual diagram illustrating a flow of image processing.

### DESCRIPTION OF EMBODIMENTS

Now, embodiments will be described in detail with reference to the drawings. The same reference characters are used to represent equivalent elements, and redundant explanation will be omitted.

### (Image Processing Device)

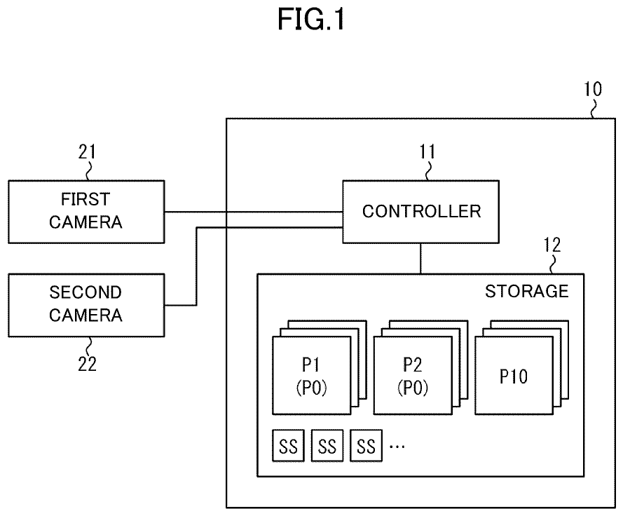

FIG. 1 illustrates a configuration of an image processing device 10 according to an embodiment. The image processing device 10 processes images obtained at each predetermined time. The image processing device 10 includes a controller 11 and a storage 12.

In this example, a first camera 21 and a second camera 22 are connected to the image processing device 10. For example, the first camera 21 and the second camera 22 are fixed at predetermined locations in a factory and face toward predetermined directions to capture images.

The first camera 21 and the second camera 22 are stereo cameras, and simultaneously capture images of target imaging regions at different viewpoints. The first camera 21 obtains a first image P1 by capturing the target imaging region at each predetermined time. The second camera 22 obtains a second image P2 by capturing the target imaging region at each predetermined time. For example, the first camera 21 and the second camera 22 are constituted by general-purpose cameras with image sensors such as CCD image sensors and CMOS image sensors. The first camera 21 and the second camera 22 are each an exemplary image device that captures a target imaging region at each predetermined time.

The image processing device 10 inputs the first image P1 obtained by the first camera 21 and the second image P2 obtained by the second camera 22. The N-th (N is an integer) second image P2 on the time axis is an image obtained at the same time as the N-th first image P1 on the time axis. In the following, the first image P1 and the second image P2 are collectively referred to as “image P0”. The pixel value of an image P0 is a brightness value (signal amount) indicating the brightness level of the target imaging region.

### [Controller]

A controller 11 is connected to components of the image processing device 10 via a signal line and controls the components of the image processing device 10. In this example, the controller 11 is connected to the storage 12 via a signal line. The controller 11 is connected to the first camera 21 and the second camera 22 via signal lines and controls the first camera 21 and the second camera 22. The controller 11 stores the first image P1 transmitted from the first camera 21 and the second image P2 transmitted from the second camera 22 in a storage 12.

For example, the controller 11 includes a processor and a memory that stores a program for operating the processor. When the program is executed by the processor, the various functions of the controller 11 are achieved. In other words, the controller 11 includes various functional blocks that achieve various functions. The controller 11 is an exemplary computer.

### [Storage]

A storage 12 stores various data and information. For example, the storage 12 stores the first image P1 transmitted from the first camera 21, the second image P2 transmitted from the second camera 22, a static image P10, a static pixel value SS, and the like. Note that the image P0 (specifically, the first image P1 and the second image P2) is associated with the time at which the image P0 is obtained. The static image P10 and the static pixel value SS are described in detail later.

### [Processes by Controller]

The controller 11 performs various processes. In this example, the controller 11 performs a static pixel value derivation process, a static image generation process, a stereo matching process, a feature image generation process, a compensation process, a recognition process, and a three dimensional data generation process. The static pixel value derivation process includes a determination process and a derivation process. The determination process is performed based on each of the first image P1 and the second image P2. The derivation process and the static image generation process are performed based on at least one of the first image P1 and the second image P2. The process performed by the controller 11 is an exemplary image processing method.

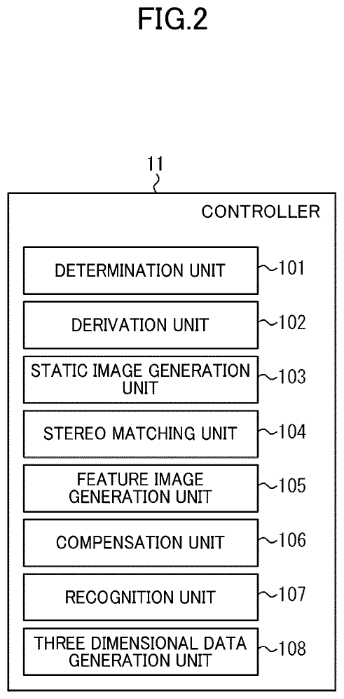

As illustrated in FIG. 2, in this example, the controller 11 includes a static pixel value derivation unit 100, a static image generation unit 103, a stereo matching unit 104, a feature image generation unit 105, a compensation unit 106, a recognition unit 107, and a three dimensional data generation unit 108.

The static pixel value derivation unit 100 performs the static pixel value derivation process. The static pixel value derivation unit 100 includes a determination unit 101 that performs the determination process and a derivation unit 102 that performs the derivation process. The static image generation unit 103 performs the static image generation process. The stereo matching unit 104 performs the stereo matching process. The feature image generation unit 105 performs the feature image generation process. The compensation unit 106 performs the compensation process. The recognition unit 107 performs the recognition process. The three dimensional data generation unit 108 performs the three dimensional data generation process. The determination unit 101 performs the process based on each of the first image P1 and the second image P2. The derivation unit 102 and the static image generation unit 103 perform the process based on at least one of the first image P1 and the second image P2.

In the static pixel value derivation process, the controller 11 (static pixel value derivation unit 100) derives the static pixel value SS of the static pixel in the image P0 based on the temporal change in the pixel value S of each pixel in the image P0. Specifically, in the static pixel value derivation process, the determination process and the derivation process are performed.

In the determination process, the controller 11 (determination unit 101) determines for each pixel in the image P0 whether the pixel is a dynamic pixel or a static pixel based on the temporal change in the pixel value S of the pixel.

In the derivation process, the controller 11 (derivation unit 102) derives for each pixel in the image P0, the static pixel value SS of the pixel based on the pixel value S, out of the pixel value S at the past time and the pixel value S at the current time of the pixel, when the pixel is determined to be a static pixel by the determination process.

In the static image generation process, the controller 11 (static image generation unit 103) generates a static image P10 indicating the static pixel value SS (static pixel value SS derived by the derivation process) for each pixel based on the static pixel value SS derived for each pixel in the image P0 through the derivation process.

### [Operation of Image Processing Device (Determination Process, Derivation Process, and Static Image Generation Process)]

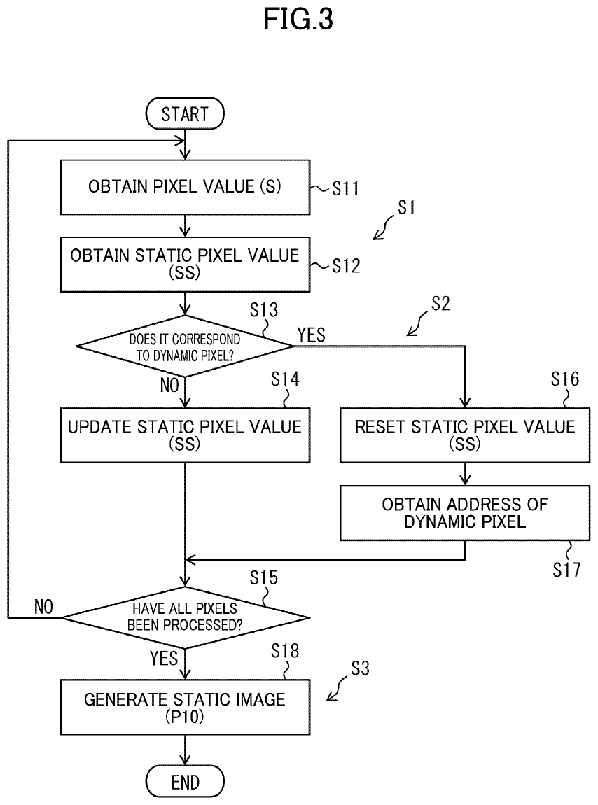

Next, operations (the determination process, the derivation process, and the static image generation process) of the image processing device 10 will be described with reference to FIG. 3. In FIG. 3, steps S11, S12, and S13 constitute a determination step S1 corresponding to the determination process. Steps S14, S16, and S17 constitute a derivation step S2 corresponding to the derivation process. A step S18 constitutes a static image generation step S3 corresponding to the static image generation process. For example, the controller 11 performs the following process each time the image P0 is obtained.

### <Step S11>

The controller 11 selects pixels to be processed from the image P0. Then, the controller 11 obtains the pixel value S of the selected pixels. The pixel selected for process in the step S11 is hereinafter referred to as a “target pixel”.

### <Step S12>

Next, the controller 11 obtains the static pixel value SS of the target pixel. In this example, the controller 11 reads the static pixel value SS of the target pixel stored in the storage 12.

### <Step S13>

Next, the controller 11 (determination unit 101) determines whether the target pixel is a dynamic pixel or a static pixel based on the temporal change in the pixel value S of the target pixel.

Specifically, the controller 11 determines that the target pixel is a dynamic pixel when the amount of temporal change in the pixel value S of the target pixel exceeds a predetermined threshold value. On the other hand, the controller 11 determines that the target pixel is a static pixel when the amount of temporal change in the pixel value S of the target pixel does not exceed the threshold value. In this example, the controller 11 derives the absolute value of the difference between the static pixel value SS of the target pixel and the pixel value S of the target pixel as “the amount of temporal change in the pixel value S of the target pixel”.

The above threshold value is set individually for each pixel in the image P0. In this example, the controller 11 (determination unit 101) sets the threshold value for each pixel in the image P0 to a value based on the static pixel value SS of the pixel. Specifically, the controller 11 sets the square root of the static pixel value SS as the threshold value.

If the target pixel is not a dynamic pixel (the target pixel is a static pixel), the process of step S14 is performed. On the other hand, if the target pixel corresponds to a dynamic pixel, the process of step S17 is performed.

### <Step S14>

If the target pixel is determined to be a static pixel in step S13, the controller 11 (derivation unit 102) derives the static pixel value SS of the target pixel based on “the static pixel value SS of the target pixel stored in the storage 12” and “the pixel value S of the target pixel”, and the static pixel value SS of the target pixel stored in the storage 12 is updated to the derived static pixel value SS.

In this example, the controller 11 sets the average value between “the static pixel value SS of the target pixel stored in the storage 12” and “the pixel value S of the target pixel” as a new static pixel value SS of the target pixel.

If the static pixel value SS derived based on the target pixel of the N-th image P0 on the time axis is “SS_{(N)}” and the static pixel value SS (a static pixel value derived based on the target pixel of the N−1th image P0 on the time axis) of the target pixel stored in the storage 12 is “SS₍ₙ₋₁₎”, the new static pixel value SS_{(N)} is expressed as in Equation 1 below.

$$[ Equation 1 ]$$

$${SS}_{( N )} = \frac{{SS}_{( N - 1 )} + {SS}_{( N )}}{2} \qquad ( 1 )$$

Where the “image P0 in which the target pixel is determined to be a static pixel” (image P0 in which the determination result of the target pixel changes from a dynamic pixel to a static pixel) immediately after the “image P0 in which the target pixel is determined to be a dynamic pixel” on the time axis is a “first image P0”, and the pixel values S of the target pixels in the first through N−1th images P0 are “S₍₁₎-S₍ₙ₋₁₎”, and if the target pixel continues to be determined to be a static pixel from the first image P0 to the N−1st image P0, the static pixel value SS₍ₙ₋₁₎ derived based on the target pixel in the N−1th image P0 is expressed as in Equation 2 below.

$$[ Equation 2 ]$$

$${SS}_{( N - 1 )} = \frac{{S}_{( 1 )} + {S}_{( 2 )} + {S}_{( 3 )} + {S}_{( 4 )} + ⋯ + {S}_{( N - 1 )}}{N - 1} \qquad ( 2 )$$

Thus, the N−1th static pixel value SS₍ₙ₋₁₎ is the average of the N−1 pixel values S₍₁₎-S₍ₙ₋₁₎. In other words, N−1 pixel values S₍₁₎-S₍ₙ₋₁₎ are used to derive the N−1th static pixel value SS₍ₙ₋₁₎.

### <Step S15>

Next, the controller 11 determines whether or not process has been completed for all pixels in the image P0. If all the pixels have been processed, the process of step S18 is performed. On the other hand, if all the pixels have not been processed, the process step S11 is performed to select the next pixel to be processed.

### <Step S16>

If the target pixel is determined to be a dynamic pixel in step S13, the controller 11 reverts the static pixel value SS of the target pixel to its initial value. In this example, the initial value is zero.

### <Step S17>

In addition, if the target pixel is determined to be a dynamic pixel in step S13, the controller 11 (determination unit 101) stores the address of the target pixel determined to be a dynamic pixel in the storage 12 in association with the image P0. In other words, the controller 11 stores dynamic pixel information indicating which pixel in which image P0 corresponds to a dynamic pixel in the storage 12. Next, the process of step S15 is performed.

### <Step S18>

The controller 11 (static image generation unit 103) generates the static image P10 indicating the static pixel value SS for each pixel based on the static pixel value SS derived for each pixel in the image by the above steps S11 to S17. The controller 11 stores the static image P10 in the storage 12.

The arrangement of pixels in the static image P10 is identical to the arrangement of pixels in the image P0. For example, if the image P0 includes m rows and n columns (m and n are integers) of pixels, the static image P10 also includes m rows and n columns of pixels. If the target pixel is a pixel in i-th row (i is an integer of 1 or greater, but not more than m) and in j-th column (j is an integer of 1 or greater, but not more than n), then the controller 11 sets the static pixel value SS in the i-th row in the j-th column of the static image P10 to a newly derived static pixel value SS (or the static pixel value SS reverted to its initial value) of the target pixel.

The static image P10 is stored in the storage 12 in association with the image P0. For example, the N-th static image P10 on the time axis is associated with the N-th image P0 on the time axis. The N-th static image P10 associated with the N-th image P0 is a collection of static pixel values SS derived based on the pixels in the N-th image P0.

The static image P10 includes not only static elements but also dynamic elements with little movement. Examples of static elements include backgrounds, stationary objects, and the like. Examples of a dynamic element include a moving object. For example, in a factory, the walls and floors of the factory correspond to the background, the housing of equipment in the factory correspond to stationary objects, and workers, robot arms, and goods being transported correspond to dynamic objects.

### [Operation of Image Processing Device (Stereo Matching Process, and the Like)]

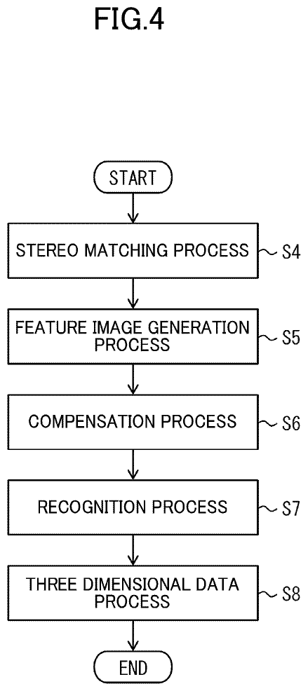

Next, the operation (stereo matching processing and the like) of the image processing device 10 will be described with reference to FIG. 4. Once the process shown in FIG. 3 is completed, the controller 11 performs the following process.

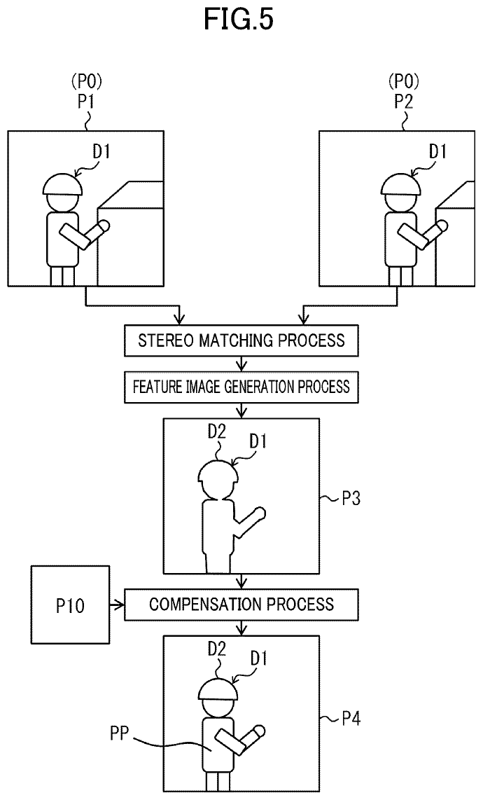

The following description refers to FIG. 5 as appropriate. In FIG. 5, the first image P1 and the second image P2 show a target imaging region where a worker stands in front of a device installed in a factory. In this example, the dynamic element D1 is the worker.

### <Step S4: Stereo Matching Step>

The controller 11 (stereo matching unit 104) performs a stereo matching process. In the stereo matching process, the controller 11 obtains parallax information regarding the dynamic element D1 shown in the first image P1 and the second image P2 by performing stereo matching to the pixels, out of the pixels in the first image P1, which are determined to be dynamic pixels in the determination process and the pixels, out of the pixels in the second image P2, which are determined to be dynamic pixels in the determination process.

The controller 11 detects “pixels determined to be dynamic pixels” from the first image P1 and the second image P2 based on dynamic pixel information (information indicating which pixels in which images are dynamic pixels) stored in the storage 12.

A known method can be adopted for the stereo matching process. For example, the controller 11 detects a block region in the second image P2 that have a high degree of coincidence with a block region selected in the first image P1 and obtains the parallax of these block regions. The parallax information is obtained by repeating the above process.

### <Step S5: Feature Image Generation Step>

Next, the controller 11 (feature image generation unit 105) performs the feature image generation process. In the feature image generation process, the controller 11 generates a feature image P3 (see FIG. 5) showing a contour portion D2 of the dynamic element D1 based on the parallax information obtained through the stereo matching process.

A known method can be adopted for the feature image generation process. For example, the controller 11 generates a distance image showing the distance (in the depth direction of the image) for each pixel as a feature image P3 based on the parallax information obtained by the stereo matching process. In the distance image, although the contour portion D2 of the dynamic element D1 appears as an edge line, the inside of the contour portion D2 is less likely to appear in the image because the distance values are almost identical.

The N-th feature image P3 on the time axis is generated based on the parallax information obtained by stereo matching for the “dynamic pixels in the N-th first image P1 on the time axis” and the “dynamic pixels in the N-th second image P2 on the time axis.

### <Step S6: Compensation Step>

Next, the controller 11 (compensation unit 106) performs the compensation process. In the compensation process, the controller 11 compensates the image portion PP inside the contour portion D2 of the dynamic element D1 shown in the feature image P3 generated through the feature image generation process based on the static image P10 generated through the static image generation process. This generates a compensation image P4 (see FIG. 5).

A known method can be adopted for the compensation process. For example, the controller 11 extracts an image portion PP having a contour portion with a high degree of coincidence with the contour portion D2 (edge line) of the dynamic element D1 shown in the feature image P3 from the static image P10, and embeds the extracted image portion PP inside the contour portion D2 of the dynamic element D1 shown in the feature image P3.

### <Step S7: Recognition Step>

Next, the controller 11 (recognition unit 107) performs a recognition process. In the recognition process, the controller 11 recognizes the dynamic element D1 from the feature image (compensation image P4) processed in the compensation process.

A known method can be adopted for the recognition process. For example, the controller 11 recognizes the dynamic element D1 from the compensation image P4 using a model obtained by machine learning such as deep learning.

### <Step S8: Three Dimensional Data Generation Step>

Next, the controller 11 (three dimensional data generation unit 108) performs the three dimensional data generation process. In the three dimensional data generation process, the controller 11 generates three dimensional data based on the first image P1 or the second image P2, the parallax information obtained through the stereo matching process, and the recognition result from the recognition process.

A known method can be adopted for the three dimensional data generation process. For example, the controller 11 generates the three dimensional data by adding information indicating the recognition result of the recognition process (information indicating in which region the dynamic element D1 is located) and distance information derived based on the parallax information (distance information indicating the distance of the dynamic element D1 in the depth direction of the image) to the first image P1 or the second image P2.

### Effects of Embodiment

As described above, in the image processing device 10 according to the embodiment, the controller 11 (static pixel value derivation unit 100) derives the static pixel value SS of the static pixel in the image P0 based on the temporal change in the pixel value S of each pixel in the image P0, in the static pixel value derivation process. In the static image generation process, the controller 11 (static image generation unit 103) generates the static image P10 indicating the static pixel value SS for each pixel based on the static pixel value SS.

Specifically, the static pixel value derivation process includes a determination process and a derivation process. In the determination process, the controller 11 (determination unit 101) determines for each pixel in the image P0 whether the pixel is a dynamic pixel or a static pixel based on the temporal change in the pixel value S of the pixel. In the derivation process, the controller 11 (derivation unit 102) derives for each pixel in the image P0, the static pixel value SS of the pixel based on the pixel value S, out of the pixel value S at the past time and the pixel value S at the current time of the pixel, when the pixel is determined to be the static pixel by the determination process. In the static image generation process, the controller 11 (static image generation unit 103) generates the static image P0 indicating the static pixel value SS for each pixel based on the static pixel value SS derived for each pixel in the image P10 by the derivation process.

In the above configuration, the static image P10 can be generated by using the pixel values S of the static pixels. The static pixel value SS can be derived based on a plurality of pixel values S (when the pixel is determined to be the static pixel) out of the past time pixel value S and the current time pixel value S of the pixel. This reduces the noise component in the static pixel value SS, thus generating a low-noise static image P10. Thus, the low-noise static image P10 can be generated by using the pixel values S of the static pixels.

In the image processing device 10 according to the embodiment, the controller 11 (derivation unit 102), during the derivation process, reverts the static pixel value SS of the pixel to the initial value for each pixel in the image P0 when the pixel is determined to be the dynamic pixel in the determination process.

If the pixel is determined to be the dynamic element, it is difficult to update the static pixel value SS by using the pixel value of that pixel. Therefore, when the pixel is determined to be the dynamic pixel, the static pixel value SS of the pixel can be properly initialized by reverting the static pixel value SS to its initial value.

In the image processing device 10 according to the embodiment, the storage 12 stores the static pixel value SS of each pixel in the image P0. In the derivation process, for each pixel in the image P0, when the pixel is determined to be the static pixel in the determination process, the controller 11 (derivation unit 102) derives the static pixel value SS of that pixel based on “the static pixel value SS of that pixel stored in the storage 12” and “the pixel value S of that pixel (of that pixel determined to be the static pixel in the determination process)” and updates the static pixel value SS of that pixel stored in the storage 12 to “the derived static pixel value SS”.

In the above configuration, the storage capacity for storing the pixel values can be reduced compared to the case where the plurality of pixel values S (pixel values S when determined to be static pixels) used for deriving the static pixel value SS are stored in the storage 12.

In the image processing device 10 according to the embodiment, during the determination process, for each pixel in the image P0, the controller 11 (determination unit 101) determines that the pixel in the image P0 is the dynamic pixel when the amount of temporal change in the pixel value S of the pixel exceeds the threshold values, and determines that the pixel is the static pixel when the amount of temporal change in the pixel value S of the pixel does not exceed the threshold values. The threshold values are individually set for each pixel of the image P0.

In the above configuration, the threshold value can be set individually for each pixel, and thus the threshold value can be set appropriately for each pixel. For example, since the threshold value can be set in consideration of the optical shot noise for each pixel, the robustness against the environmental light fluctuation can be improved.

In the image processing device 10 according to the embodiment, the controller 11 (determination unit 101) sets the threshold value for each pixel in the image P0 to a value based on the static pixel value SS of the pixel.

In the above configuration, the threshold can be set to a low-noise threshold value by setting the threshold value based on the static pixel value SS. This improves the accuracy of the determination process.

Further, in the image processing device 10 of the embodiment, the controller 11 (the stereo matching unit 104), during the stereo matching process, obtains parallax information regarding the dynamic element shown in the first image P1 and the second image P2 by performing stereo matching to the pixels, out of the pixels in the first image P1, which are determined to be dynamic pixels in the determination process and the pixels, out of the pixels in the second image P2, which are determined to be dynamic pixels in the determination process.

In the above configuration, the dynamic pixels are set as the target of stereo matching while the static pixels are not set as the target of stereo matching, in each of the first image P1 and the second image P2, thereby reducing the processing load required for stereo matching.

In the image processing device 10 according to the embodiment, the controller 11 (compensation unit 106), during the compensation process, compensates the image portion PP inside the contour portion D2 of the dynamic element D1 shown in the feature image P3 generated through the feature image generation process based on the static image P10 generated through the static image generation process. In the recognition process, the controller 11 (recognition unit 107) recognizes the dynamic element D1 from the feature image (compensation image P4) processed by the compensation process.

In the above configuration, by compensating the feature image P3, the recognition process can be performed based on not only the contour portion D2 of the dynamic elements D1 shown in the feature image P3 but also the image portion PP compensated inside the contour portion D2. This improves the accuracy of the recognition process.

### Variation of Embodiment

The derivation process (specifically, step S14) of the image processing device 10 according to a variation of the embodiment differs from that of the image processing device 10 according to the embodiment. Other configurations and processes of the image processing device 10 according to the variation of the embodiment are the same as those of the image processing device 10 according to the embodiment.

In the step S14 according to the variation of the embodiment, when the target pixel is determined to be the static pixel in step S13, the controller 11 (derivation unit 102) derives the static pixel value SS of the target pixel based on “the static pixel value SS of the target pixel stored in the storage 12” and “the pixel value S of the target pixel”, so that “the static pixel value SS of the target pixel stored in the storage 12” becomes more important than “the pixel value S of the target pixel”, with an increase in the number of the pixel values S used to derive the static pixel value SS of the target pixel stored in the storage 12.

In this example, the controller 11 weighs “the static pixel value SS of the target pixel stored in the storage 12” according to the number of pixel values S used to derive “the static pixel value SS of the target pixel stored in the storage 12”, and sets, as a new static pixel value SS of the target pixel, the value obtained by averaging the weighed “static pixel value SS of the target pixel stored in the storage 12” and “the pixel value S of the target pixel” (weighted average).

Specifically, where the static pixel value SS derived based on the target pixel of the N-th image P0 on the time axis is “SS(N)” and the static pixel value SS (a static pixel value derived based on the target pixel of the N−1th image P0 on the time axis) of the target pixel stored in the storage 12 is “SS(n−1)”, the new static pixel value SS(N) is expressed as in Equation 3 below.

$$[ Equation 3 ]$$

$${SS}_{( N )} = \frac{{SS}_{( N - 1 )} ( N - 1 ) + {S}_{( N )}}{2} \qquad ( 3 )$$

### Effects of Variation of Embodiment

As described above, in the image processing device 10 according the variation of the embodiment, in the derivation process, for each pixel in the image P0, when the pixel is determined to be the static pixel in the determination process, the controller 11 (derivation unit 102) derives the static pixel value SS of the pixel based on “the static pixel value SS of that pixel stored in the storage 12” and “the pixel value S of that pixel (of that pixel determined to be the static pixel in the determination process)”, so that the static pixel value SS of that pixel stored in the storage 12 becomes more important than the pixel value S of that pixel (of that pixel determined to be the static pixel in the determination process), with an increase in the number of the pixel values S used to derive the static pixel value SS of that pixel stored in the storage 12.

Note that the greater the number of pixel values S used to derive the static pixel value SS, the closer the static pixel value SS can be brought to a true value (a value that does not include noise), and the reliability of the static pixel value SS becomes higher. Therefore, the reliability of the newly derived static pixel value SS can be easily maintained by placing more importance on the static pixel value SS stored in the storage 12, with an increase in the number of pixel values S viewed to derive the static pixel value SS stored in storage 12.

### OTHER EMBODIMENTS

The above description deals with a case where the image processing device 10 processes the first image P1 and the second image P2 obtained by the stereo cameras (first camera 21 and second camera 22); however, the present disclosure is not limited to this. For example, the image processing device 10 may be configured to process an image obtained by a single camera. In this case, the controller 11 may be configured to perform another process (e.g., another process to obtain distance information based on images) instead of the stereo matching process.

Further, the embodiments described above may be combined as needed. The embodiments described above are mere preferred examples in nature, and not intended to limit the scope, applications, or use of the disclosure.

### INDUSTRIAL APPLICABILITY

As described above, the technology disclosed herein is useful as an image processing device and a image processing method.

### DESCRIPTION OF REFERENCE CHARACTERS

10 Image Processing Device
11 Controller
12 Storage
21 First Camera
22 Second Camera
100 Static Pixel Value Derivation Unit
101 Determination Unit
102 Derivation Unit
103 Static Image Generation Unit
104 Stereo Matching Unit
105 Feature Image Generation Unit
106 Compensation Unit
107 Recognition Unit
108 Three Dimensional Data Generation Unit
P0 Image
P1 First Image
P2 Second Image
P3 Feature Image
P4 Compensation Image
P10 Static Image

1. An image processing device that processes an image captured by an image device at each predetermined time, comprising
a controller connected to the image device,
the controller including
a static pixel value derivation unit configured to derive a static pixel value of a static pixel in an image, based on a temporal change in a pixel value of each pixel in the image, and
a static image generation unit configured to generate a static image indicating a static pixel value for each pixel based on the static pixel value.

2. The image processing device of claim 1, wherein
the static pixel value derivation unit includes:
a determination unit configured to determine, for each pixel of the image, whether the pixel is a dynamic pixel or a static pixel based on a temporal change in a pixel value of the pixel; and
a derivation unit configured to derive, for each pixel in the image, the static pixel value of the pixel based on a pixel value, out of a past time pixel value and a current time pixel value, when the determination unit determines that the pixel is the static pixel, and
the static image generation unit generates the static image indicating the static pixel value for each pixel based on the static pixel value derived for each pixel in the image by the derivation unit.

3. The image processing device of claim 2, wherein
the derivation unit reverts, for each pixel in the image, the static pixel value of the pixel to its initial value when the determination unit determines that the pixel is the dynamic pixel.

4. The image processing device of claim 2, comprising:
a storage that stores the static pixel value for each pixel in the image, wherein
for each pixel in the image, when the determination unit determines that the pixel is the static pixel, the derivation unit derives the static pixel value of the pixel based on the static pixel value of the pixel stored in the storage and the pixel value of the pixel determined to be the static pixel, and updates the static pixel value of the pixel stored in the storage to the derived static pixel value.

5. The image processing device of claim 4, wherein
for each pixel in the image, when the determination unit determines that the pixel is the static pixel, the derivation unit derives the static pixel value of the pixel based on the static pixel value of the pixel stored in the storage and the pixel value of the pixel determined to be the static pixel so that the static pixel value of the pixel stored in the storage becomes more important than the pixel value of the pixel that is determined to be the static pixel with an increase in the number of pixel values used to derive the static pixel value of the pixel stored in the storage.

6. The image processing device of claim 2, wherein
the determination unit determines, for each pixel in the image, that the pixel in the image is the dynamic pixel when the amount of temporal change in the pixel value of the pixel exceeds a threshold value, and determines that the pixel is the static pixel when the amount of temporal change in the pixel value of the pixel does not exceed the threshold value, and
the threshold value is set individually for each pixel in the image.

7. The image processing device of claim 6, wherein
the determination unit sets the threshold value for each pixel in the image to a value based on the static pixel value of the pixel.

8. The image processing device of claim 2, wherein
a first image and a second image with a different viewpoint are obtained at each predetermined time,
the determination unit performs the process based on each of the first image and the second image,
the derivation unit and the static image generation unit perform the process based on at least one of the first image and the second image,
the controller includes:
a stereo matching unit that obtains parallax information of a dynamic element shown in the first image and the second image by performing stereo matching to pixels, out of the pixels in the first image, which are determined to be dynamic pixels by the determination unit and pixels, out of the pixels in the second image, which are determined to be dynamic pixels by the determination unit;
a feature image generation unit that generates a feature image showing a contour portion of the dynamic element based on the parallax information obtained by the stereo matching unit;
a compensation unit that compensates an image portion inside the contour portion of the dynamic element shown in the feature image generated by the feature image generation unit, based on the static image generated by the static image generation unit; and
a recognition unit that recognizes the dynamic element from the feature image processed by the compensation unit.

9. An image processing method that processes an image captured by an image device at each predetermined time, comprising:
deriving a static pixel value of a static pixel in an image based on a temporal change in the pixel value of each pixel in the image, and
generating a static image indicating a static pixel value for each pixel based on the static pixel value.
